(19) United States
(12) Patent Application Publication
(10) Pub. No.: US 2004/0184008 A1
(43) Pub. Date: Sep. 23, 2004

(54) PROJECTION DISPLAY DEVICE

(76) Inventors: Chun-Yao CHEN, Miao-Li County (TW); Yung-Chuan TSENG, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,505

(22) Filed: Mar. 9, 2004

(30) Foreign Application Priority Data
Mar. 12, 2003 (TW) 092204093

(51) Int. Cl. G03B 21/18

(52) U.S. Cl. 353/57

(57) ABSTRACT

A projection display device includes a casing, lamp installed in the casing, optical engine and lamp cooling apparatus, in which the lamp apparatus includes a fan, recess and lamp cover. The fan is installed at the bottom part of the lamp, and the recess is opened on the casing and located below the fan. The lamp cover is installed outside of the lamp so as to allow a convection space to be formed between the outside of the lamp and the lamp cover. The air with low thermal load at the lower side of the display device is drawn in through the fan to enter the convection space to cool the lamp so as to enhance the cooling effect for the projection display device.

### BACKGROUND OF INVENTION

1. Field of the Invention

The present invention relates to a projection display device, and more particularly to a projection display device capable of enhancing a cooling effect.

2. Description of the Prior Art

A lamp is used to provide needed light flux for a projection display device. However, for conforming to the applications of projection display device on a high illumination occasion such as a video briefing or home movie theater, a high power consumption of lamp is generally used. But, a great amount of heat is yielded from the lamp to cause the lamp to be damaged easily and device functions to be influenced.

Please refer to FIG. 1. A conventional cooling device of a lamp of a projection display device comprises a lamp 11A and a fan 12 installed behind the lamp 11A. Air in the device is inhaled by the fan 12 to flow through the flank sides of the lamp 11A to process cooling on the lamp 11A, and then is expelled out from an air outlet (not shown in the figure) to attain a cooling effect. The disposition of a single air passageway is adopted in a general projection display device; the air cools down optical elements with lower temperature first, and this causes the density of air current to be different and to yield a phenomena that the air is cooler at the lower side of the device and hotter at the upper side thereof. The fan 12 installed behind the lamp 11A is further used to cool down the lamp 11A. At this time, the hotter air is drawn through the upper side of the fan 12 and the cooler air is drawn through the lower side of the fan 12. But, because the thermal load of hot air is rather high, the heat at the upper side of the lamp cannot be carried away effectively so that a perfect cooling effect cannot be attained.

Furthermore, please refer to FIG. 2. A bottom surface 131 of a casing 13 of another conventional projection display device has a distance from a table surface 14. A vent 132 is disposed at the bottom of the casing 13. The cool air outside of the device is drawn in through the vent 132 to cool a lamp 11B so as to enhance a cooling effect. But, because the table surface is easily attached with dust and impurities in the environment, a great amount of dust is drawn in the device by inhaling the outside cool air close to the table surface with the result that the functions of the elements in the projection display device is influenced. Therefore, a dustproof structure must be further installed to filter the air to ensure the functions of the device when the way inhaling outside cool air from bottom is adopted.

### SUMMARY OF INVENTION

One object of the present invention is to provide a projection display device, capable of inhaling air with low thermal load to cool a lamp by disposing a fan at the bottom part of the lamp so as to enhance a cooling effect.

Another object of the present invention is to provide a projection display device, capable of increasing air flux by opening a recess below a fan.

Still another object of the present invention is to provide a projection display device, in which clean air in the device is directly used to cool a lamp without inhaling outside air through a vent opened at the bottom of a casing so that dust can be prevented from drawing into the device when the outside air is inhaled. Therefore, a dustproof solution can be attainted and a cooling device can be simplified without further installing a dustproof structure to filter air.

For attaining the objects mentioned above, a projection display device according to present invention comprises a casing, a lamp installed in the casing, an optical engine module and a lamp cooling apparatus, in which the lamp cooling apparatus comprises a fan, recess and lamp cover. The fan is installed at the bottom part of the lamp, the recess is disposed below the fan and the lamp cover is installed outside of the lamp so as to allow a convection space is formed between the lamp cover and the lamp. An air inlet and an air outlet are respectively disposed at the places on the lamp cover relative to the bottom part and the top part of the lamp, in which the fan is located at the air inlet. Whereby, the cooling effect of the projection display device can be enhanced by drawing air with low thermal load at the lower side of the display device through the fan to enter the convection space to cool the lamp.

### BRIEF DESCRIPTION OF DRAWINGS

The present invention can be more fully understood by reference to the following description and accompanying drawings, in which:

FIG. 1 is a schematic view, showing a conventional structure of a lamp cooling apparatus;

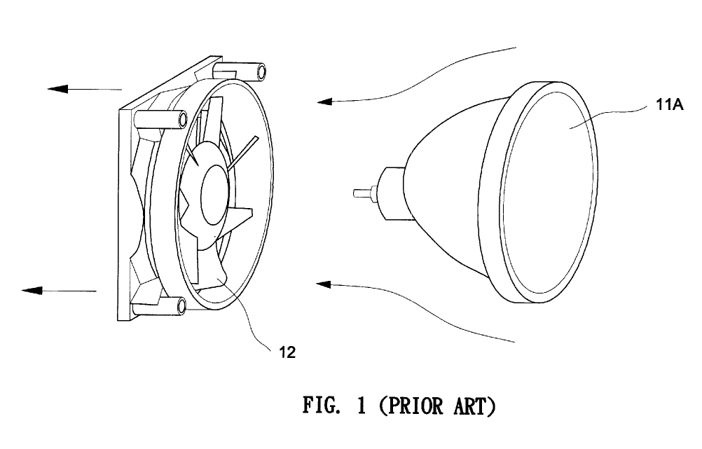

FIG. 2 is a side cross-sectional view, showing a conventional projection display device;

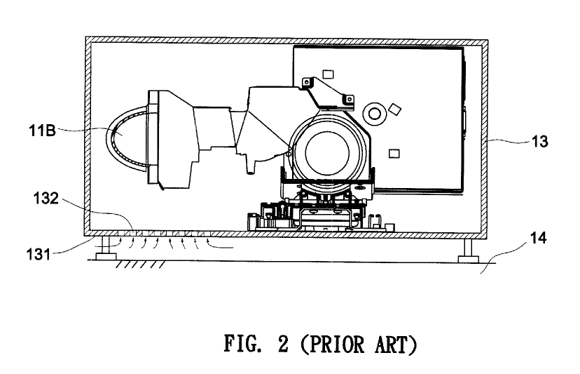

FIG. 3 is a side cross-sectional view, showing a projection display device according to the present invention; and

FIG. 4 is a three-dimensional prospective view, showing a lamp cooling apparatus according to the present invention.

### DETAILED DESCRIPTION

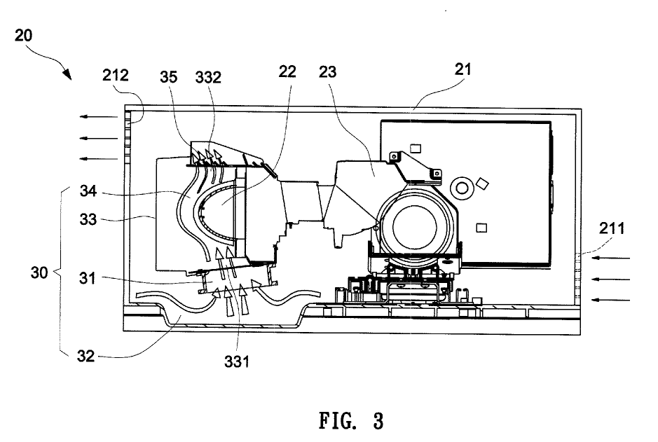

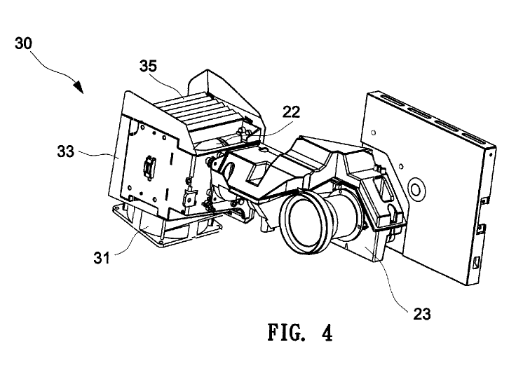

Please refer to FIGS. 3 and 4. A lamp cooling apparatus 30 is applied in a projection display device 20. The projection display device 20 comprises a casing 21, lamp 22 installed in the casing 21, optical engine 23 and the lamp cooling apparatus 30. An air inlet and air outlet are respectively disposed at the opposite flank sides of the casing 21 and a passageway for clean airflow is formed between them. The lamp 22 is used to provide beams for illumination. The optical engine 23 is combined with the lamp 22 to form one body so as to transform the illumination beams into image beams. The lamp cooling apparatus 30 comprises a fan 31, recess 32 and lamp cover 33. The fan 31 is installed at the bottom part of the lamp 22 and the recess 32 is opened on the casing 21 and located below the fan 31 so as to increase the air influx for the fan 31. The lamp cover 33 is covered outside of the lamp 22 to allow a convection space 34 to be formed between the outside of the lamp 22 and the lamp cover 33. An air inlet 331 and air outlet 332 for the lamp cover 33 are respectively opened at the bottom and the top of the lamp. The fan 31 is disposed to face the air inlet 331 and diversion plates 35 are installed at the air outlet 332 to guide the air in the convection space 34 to be exhaled from the air outlet 212 of the display device.

The air below the projection display device 20 is drawn in by the fan 31 installed below the air inlet 331 at the bottom of the lamp 22 to enter the convection space 34. The drawn-in air flows along the outside surface of the lamp to cool the lamp 22 and finally is expelled from the air outlet 332 at the upper side of the lamp 22. Because the air in the display device is cooler at the upper side thereof and hotter at the lower side thereof, the arrangement that the air inlet 331 is installed at the bottom of the lamp 22 (i.e. the bottom of the projection display device 20) can allow the cool air with low thermal load in the projection display device 20 to be drawn in to cool the lamp 22. Therefore, a better cooling effect can be attained. Besides, the recess 32 disposed below the fan 31 is used to increase the air influx for the fan 31 so as to enforce a cooling effect.

Furthermore, the air with low thermal load for cooling the lamp 22 mentioned above is the clean air drawn in by the fan 31 directly from the bottom part in the display device and is not the outside air drawn in from the vent at the bottom of the casing. Therefore, the further installment of a dustproof structure for filtering air is unnecessary and meanwhile the problem that dust is inhaled into the display device when the outside air is drawn therein can be prevented so that the cooling apparatus can be simplified and the dustproof effect for the display device can be attained.

It is noted that the projection display device described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A projection display device, comprising:
a casing;
an optical engine, installed in said casing, and comprising a lamp; and
a lamp cooling apparatus, installed in said casing, and comprising a fan and recess, said fan being installed at the bottom part of said lamp and said recess being disposed below said fan.

2. The device according to claim 1, wherein said recess of said lamp cooling apparatus is disposed on said casing.

3. The device according to claim 1, wherein said projection display device further comprises an air inlet and air outlet, and said air inlet and said air outlet are respectively disposed at opposite flank sides of said casing.

4. The device according to claim 1, wherein said lamp cooling apparatus further comprises a lamp cover, said lamp cover is installed outside of said lamp, and a convection space is formed between said lamp cover and said lamp.

5. The device according to claim 4, wherein an air inlet and an air outlet are respectively disposed at the places on said lamp cover relative to the bottom and the top of said lamp.

6. The device according to claim 5, wherein said fan is installed at said air inlet.

7. The device according to claim 5, wherein diversion plates are installed at said air outlet.

8. A lamp cooling apparatus, comprising:
a fan, installed at the bottom part of said lamp; and
a recess, disposed below said fan.

9. The apparatus according to claim 8, further comprising a lamp cover, installed outside of said lamp, a convection space is formed between said lamp cover and said lamp.

10. The apparatus according to claim 9, wherein a air inlet and air outlet are respectively disposed at the places on said lamp cover relative to the top and the bottom of said lamp.

11. The apparatus according to claim 10, wherein said fan is installed at said air inlet.

12. The apparatus according to claim 10, wherein diversion plates are installed at said air outlet.
